(19) United States
(12) Patent Application Publication
(10) Pub. No.: US 2026/0237556 A1
(43) Pub. Date: Aug. 13, 2026

(54) ROTARY SYSTEM HAVING A RESOLVER

(71) Applicant: Schaeffler Technologies AG & Co. KG, Herzogenaurach (DE)

(72) Inventor: Trent Hendershot, Wooster, OH (US)

(73) Assignee: Schaeffler Technologies AG & Co. KG, Herzogenaurach (DE)

(21) Appl. No.: 19/050,652

(22) Filed: Feb. 11, 2025

(51) Int. Cl. H01F 38/18; H01F 41/00; H02K 24/00

(52) U.S. Cl. CPC H01F 38/18; H01F 41/00; H02K 24/00

(57) ABSTRACT

A rotary system includes a rotational component operable to rotate about an axis and having a base portion, a collar that extends axially outward from the base portion, and a flange that extends radially-outboard from the collar. A resolver is disposed axially between the base portion and the flange, wherein the base portion and the flange contact the resolver to limit axial deformation of the resolver.

### FIELD OF THE DISCLOSURE

The present disclosure generally relates to a rotary system. More specifically, the present disclosure relates to a rotary system, such as a torque converter or an electric motor assembly that includes a resolver.

### BACKGROUND OF THE DISCLOSURE

Rotary systems sometimes utilize resolvers to measure rotational position.

### SUMMARY OF THE DISCLOSURE

According to a first aspect of the present disclosure, a rotary system includes a rotational component operable to rotate about an axis and having a base portion, a collar that extends axially outward from the base portion, and a flange that extends radially-outboard from the collar. A resolver is disposed axially between the base portion and the flange, wherein the base portion and the flange contact the resolver to limit axial deformation of the resolver.

Embodiments of the first aspect of the disclosure can include any one or a combination of the following features:
the collar defines a recess, and the resolver includes a locator tab that is received within the recess defined by the collar;
the collar continuously extends circumferentially from a first portion of the recess to a second portion of the recess;
the collar defines a plurality of recesses and the resolver includes a corresponding plurality of locator tabs respectively received within the plurality of recesses;
the plurality of recesses includes a first recess and a second recess in a spaced relationship with and adjacent to the first recess, wherein a portion of the collar continuously extends circumferentially from the first recess to the second recess at least 60 degrees;
the rotational component is a portion of a torque converter;
the rotational component is an impeller of the torque converter;
the rotational component is a portion of an electric motor assembly; and
the rotational component is a portion of a rotor hub of the electric motor assembly.

According a second aspect of the present disclosure, a method of assembling a resolver with a rotational component configured to rotate about an axis, includes the steps of: disposing a resolver about a collar of the rotational component, such that the resolver contacts a base portion of the rotational component that extends radially outboard relative to the collar; and deforming the collar via forcible contact between the collar and a roller to form, from a portion of the collar, a flange that extends radially-outboard from an adjacent portion of the collar, wherein the resolver is disposed axially between the base portion and the flange to limit axial deformation of the resolver.

Embodiments of the first aspect of the disclosure can include any one or a combination of the following features and steps:
in the step of deforming the collar, the roller rolls about a first axis as relative rotation of the roller and the rotational component occurs about a second axis, such that the roller rolls about at least a portion of the collar in forming the flange;
in the step of deforming the collar, the rotational component moves axially toward the roller via a force applied to the rotational component;
in the step of deforming the collar, the roller moves axially toward the rotational component via a force applied to the roller;
the roller is a first roller and a second roller in a spaced relationship with the first roller is operable to roll about the first axis, wherein, in the step of deforming the collar, the first and second rollers roll about the first axis as relative rotation of the first and second rollers and the rotational component occurs about the second axis, such that the first and second rollers roll about the collar in forming the flange;
the second axis is substantially colinear to the axis about which the rotational component is configured to rotate;
in the step of deforming the collar, the roller rotates relative to the rotational component about the second axis;
in the step of deforming the collar, the rotational component rotates relative to the roller about the second axis;
the rotational component is an impeller for a torque converter; and
the rotational component is a portion of a rotor hub for an electric motor.

According to a third aspect of the present disclosure, an electric motor assembly includes a rotor configured to rotate about an axis. A rotor hub is coupled with the rotor and includes a central component, a portion of which is axially aligned with the rotor, and an outer component mounted to the central component at a position that is axially offset from the rotor. The outer component includes a base portion. A collar extends axially outward from the base portion. A flange extends radially-outboard from the collar distally from the base portion. A resolver is disposed axially between the base portion and the flange, wherein the base portion and the flange contact the resolver to limit axial deformation of the resolver.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a portion of an electric motor assembly that includes a resolver disposed on the portion of the electric motor assembly, according to one embodiment;

FIG. 2 is a cross-sectional view of a portion of an electric motor assembly and manufacturing machinery, including a roller that is configured to deform a portion of the electric motor assembly to retain a resolver thereon, according to one embodiment;

FIG. 3 is a perspective view of a portion of a torque converter assembly that includes a collar, a resolver that is disposed about the collar, and first and second rollers that are in contact with the collar of the portion of the torque converter assembly, according to one embodiment;

FIG. 4 is a cross-sectional view of the rollers and the portion of the torque converter illustrated in FIG. 3, according to one embodiment;

FIG. 5A is a cross-sectional view of a portion of a rotational component that includes a base and a collar portion, wherein a resolver is disposed about the collar portion in contact with the base, and a roller contacts the collar portion distally from the base portion of the rotational component, according to one embodiment;

FIG. 5B is a cross-sectional view of the portion of the rotational component, illustrating the rotational component moved further toward the roller relative to FIG. 5A, such that the collar is partially deformed via the forcible contact between the collar and the roller, according to one embodiment;

FIG. 5C is a cross-sectional view of a portion of the rotational component, illustrating further convergence between the rotational component and the roller, relative to FIG. 5B, such that the forcible contact between the collar of the rotational component and the roller prompts deformation of the collar, forming a flange that contacts the resolver opposite the base portion of the rotational component, according to one embodiment;

FIG. 6 is a perspective view of a portion of a torque converter, illustrating a base portion, a collar, and a flange, wherein the base portion and the flange cooperate to limit axial deformation of a resolver received therebetween, according to one embodiment; and FIG. 7 is a flow diagram illustrating the steps of a method of assembling a resolver with the rotational component, according to one embodiment.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis that a rotational component is configured to rotate in operation of the apparatus described herein. Further, the term “radial” and derivatives thereof, such as “radially,” shall be understood in relation to the axis of the aforementioned shaft. For example, “radially outboard” refers to further away from the axis, while “radially inboard” refers to nearer to the axis. The term “circumferential” and derivatives thereof, such as “circumferentially,” shall be understood in relation to the axis of the aforementioned rotational component.

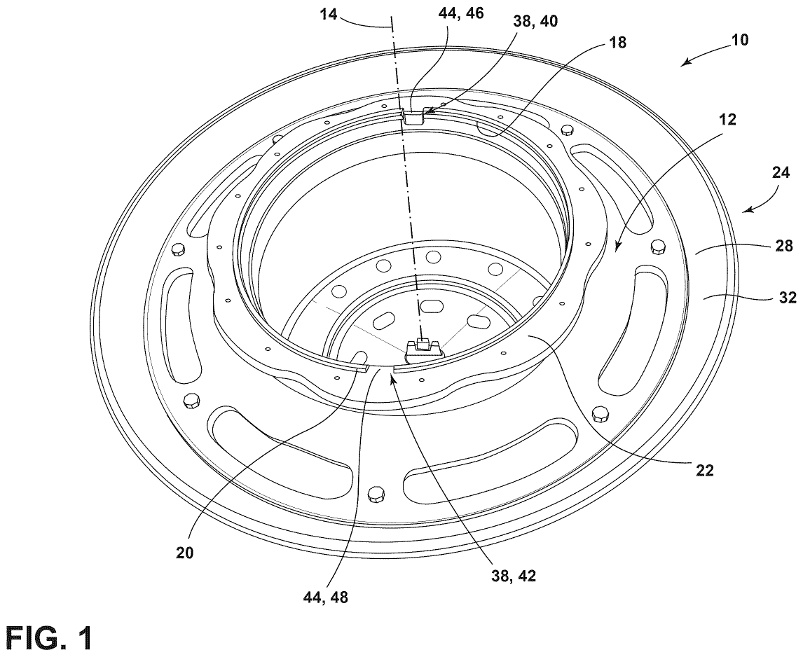

Referring now to FIGS. 1-7, a rotary system 10 includes a rotational component 12. The rotational component 12 is operable to rotate about an axis 14. The rotational component 12 includes a base portion 16, a collar 18 that extends axially outward from the base portion 16, and a flange 20 that extends radially-outboard from the collar 18. A resolver 22 is disposed axially between the base portion 16 and the flange 20. The base portion 16 and the flange 20 contact the resolver 22 to limit axial deformation of the resolver 22.

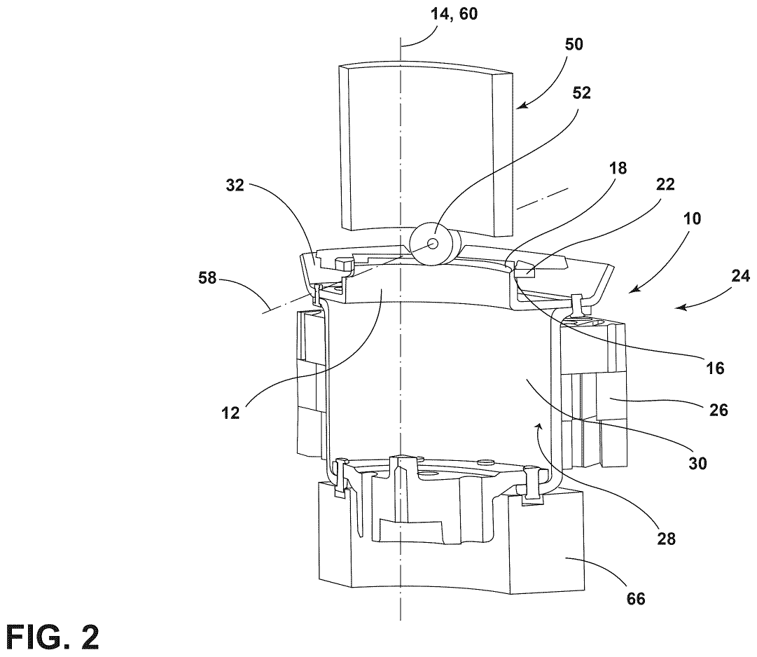

Referring now to FIGS. 1-4 and 6, in various implementations, the rotary system 10 may be an electric motor assembly 24. For example, in FIGS. 1 and 2, portions of the electric motor assembly 24 are illustrated. In the embodiment illustrated in FIG. 2, the electric motor assembly 24 includes a rotor 26 that is configured to rotate about the axis 14. A rotor hub 28 is coupled with the rotor 26 and includes a central component 30 and an outer component 32. A portion of the central component 30 is axially aligned with the rotor 26. The outer component 32 is mounted to the central component 30 at a position that is axially offset from the rotor 26 of the electric motor assembly 24. The outer component 32 of the rotor hub 28 includes the base portion 16, the collar 18 that extends axially outward from the base portion 16, and the flange 20 that extends radially-outboard from the collar 18 distally from the base portion 16. The resolver 22 is disposed axially between the base portion 16 and the flange 20, and the base portion 16 and the flange 20 contact the resolver 22 to limit axial deformation of the resolver 22, as described further herein.

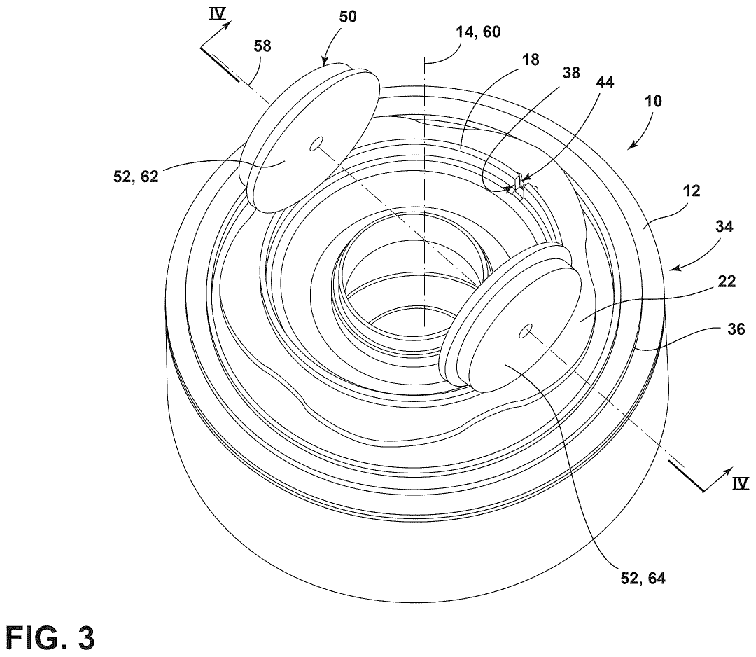

In some embodiments, the rotary system 10 is a torque converter 34. For example, as illustrated in FIGS. 3, 4, and 6, the rotary system 10 is the torque converter 34, and the rotational component 12 of the rotary system 10 is embodied as an impeller 36 of the torque converter 34. As illustrated, the impeller 36 of the torque converter 34 includes the base portion 16, the collar 18 that extends axially outward from the base portion 16, and the flange 20 that extends radially-outboard from the collar 18 distally from the base portion 16. As illustrated in FIG. 6, the resolver 22 is disposed axially between the base portion 16 and the flange 20, which extends over a portion of the resolver 22. The base portion 16 and the flange 20 contact the resolver 22 to limit axial deformation of the resolver 22, in various embodiments. A variety of types of rotary systems 10 and/or rotational components 12 that the resolver 22 may be disposed on are contemplated.

Referring still to FIGS. 1-4 and 6, in various implementations, the resolver 22 may be generally ring-shaped, defining an aperture that extends therethrough. In various embodiments, the resolver 22 is formed of a plurality of laminations that are stacked upon one another to form the generally ring-shaped structure. The resolver 22 may be configured to measure the position, speed, and/or direction of rotation of the rotational component 12 of the rotary system 10, in various embodiment. As used herein, the resolver 22 may be synonymous with a resolver rotor, in some implementations.

Referring now to FIGS. 1 and 3, in some implementations, the collar 18 of the rotational component 12 defines a recess 38. For example, as illustrated in FIG. 3, the collar 18 defines the recess 38 and extends circumferentially about the axis 14 from a first portion of the recess 38 to a second portion of the recess 38. In some implementations, the collar 18 defines a plurality of recesses 38. For example, as illustrated in FIG. 1, the collar 18 of the rotational component 12 includes a first recess 40 and a second recess 42 that is in a spaced relationship with the first recess 40. The second recess 42 is adjacent to the first recess 40, and a portion of the collar 18 continuously extends circumferentially from the first recess 40 to the second recess 42. In the illustrated embodiment, a portion of the collar 18 continuously extends circumferentially from the first recess 40 to the second recess 42 about 180 degrees. A variety of circumferential extents between the first and second recesses 40, 42 are contemplated. In various implementations, the portion of the collar 18 that continuously extends circumferentially from the first recess 40 of the second recess 42 may extend at least 60 degrees from the first recess 40 to the second recess 42. Further, it is contemplated that the collar 18 may define more than the first and second recesses 40, 42 in various implementations.

Referring still to FIGS. 1 and 3, the resolver 22 can include a locator tab 44 that is configured to be received within the recess 38 defined by the collar 18 of the rotational component 12. As illustrated in FIG. 3, the locator tab 44 may extend radially inboard from the adjacent portion of the resolver 22 into the recess 38 defined by the collar 18. As illustrated in FIG. 1, in some embodiments, the resolver 22 can include a plurality of locator tabs 44. In the illustrated embodiment, the resolver 22 includes a first locator tab 46 and a second locator tab 48 that is in a spaced relationship with the first locator tab 46. The locator tab 44 of the resolver 22 is configured to be received within the recess 38 defined by the collar 18 of the rotational component 12. In the embodiment illustrated in FIG. 1, the first and second locator tabs 46, 48 are respectively received within the first and second recesses 40, 42 defined by the collar 18 of the rotational component 12. In various implementations, the locator tab 44 being received within the corresponding recess 38 defined by the collar 18 of the rotational component 12 may advantageously prevent and/or limit rotational displacement of the resolver 22 relative to the rotational component 12. Additionally, the one or more locator tabs 46, 48 aligning with the one or more recesses 40, 42 may enable intuitive assembly of the resolver 22 about the collar 18 initially. As illustrated in FIGS. 1 and 3, the recess 38 defined by the collar 18 may also be defined by the flange 20, in various implementations.

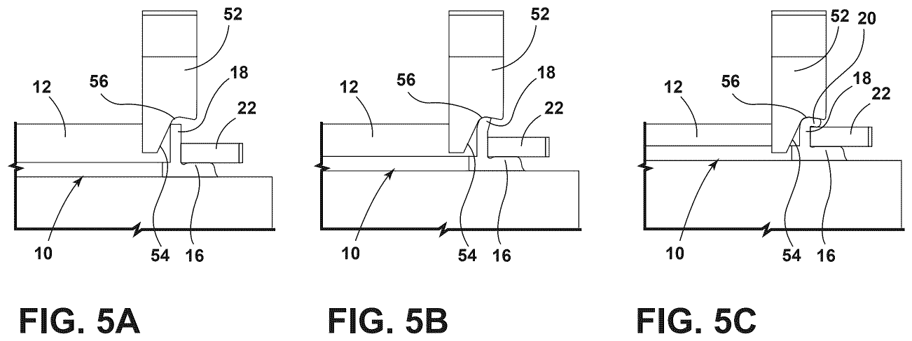

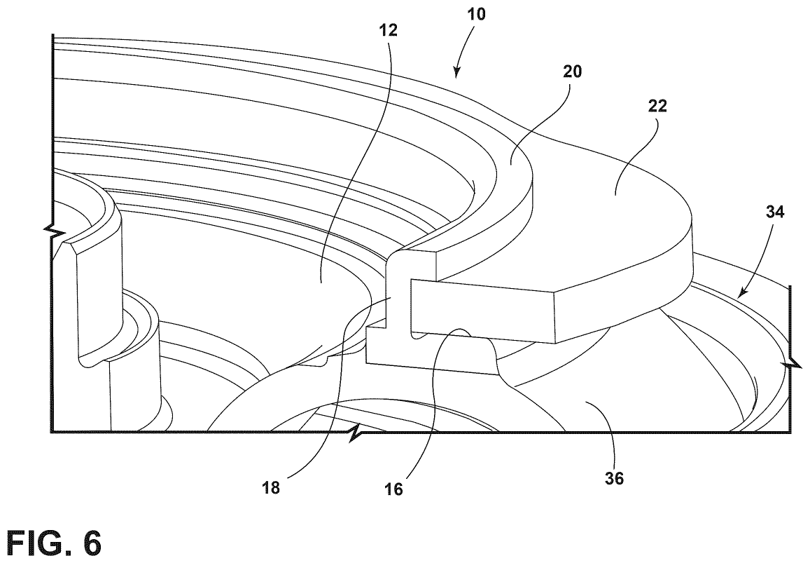

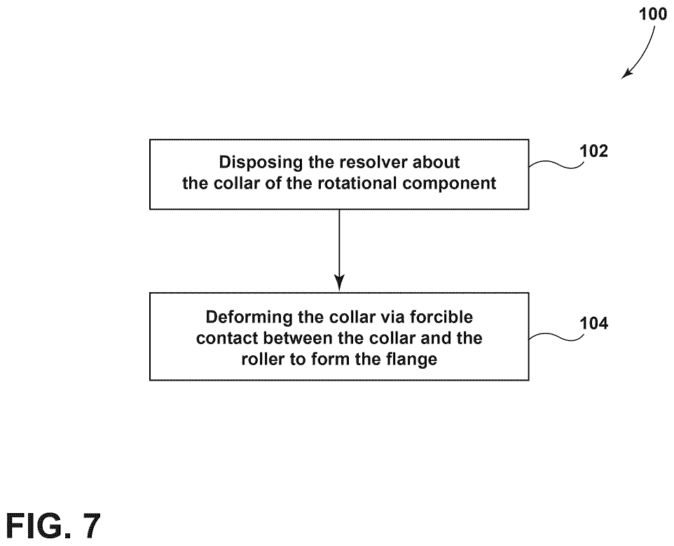

Referring now to FIGS. 1-6, in various implementations, in the process of manufacturing the rotary system 10 such that the resolver 22 is secured to the rotational component 12 of the rotary system 10, the resolver 22 is disposed about the collar 18 (i.e., the collar 18 extends through an aperture defined by the ring-shaped resolver 22), and the collar 18 is deformed to form the flange 20 that aids in securing the resolver 22 to the rotational component 12. In an exemplary implementation, a manufacturing apparatus 50 includes a roller 52 that is configured to deform the collar 18 of the rotational component 12 to form the flange 20. As described further herein, the roller 52 and the rotational component 12 forcibly converge, causing deformation of the flange 20 as illustrated sequentially in FIGS. 5A-5C. As illustrated, the roller 52 includes a tapered surface 54 that turns at a corner 56. The tapered surface 54 that turns at the corner 56 shapes the collar 18 as the collar 18 deforms into the flange 20. In various implementations, the roller 52 is configured to roll about a first axis 58 as relative rotation of the roller 52 and the rotational component 12 occurs about a second axis 60, such that the roller 52 rolls about at least a portion of the collar 18 in forming the flange 20. In various implementations, this rolling of the roller 52 along the collar 18 while relative rotation between the rotational component 12 and the roller 52 occurs, allows for uniform formation of the flange 20 with improved force distribution on the collar 18 relative to other methods of fixing a resolver to a rotational component, such as stamping.

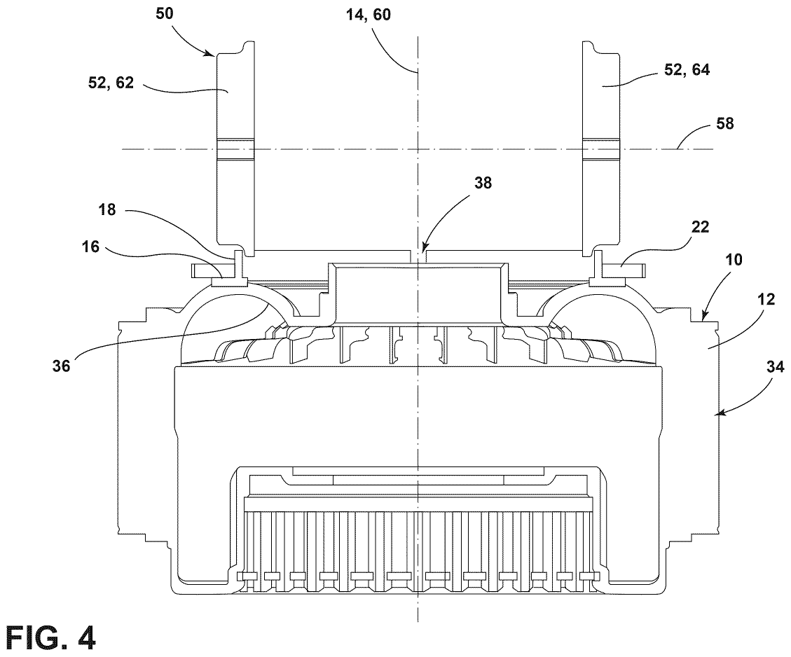

As illustrated in FIGS. 3 and 4, in some implementations, the manufacturing apparatus 50 includes a first roller 62 and a second roller 64 that is in a spaced relationship with the first roller 62. The first and second 62, 64 rollers maybe operable to roll about the first axis 58. The first and second rollers 62, 64 may simultaneously roll along the collar 18 of the rotational component 12 during manufacturing to form the flange 20, thereby further distributing the force along the rotational component 12. In various implementations, the forcible contact between the roller 52 of the manufacturing apparatus 50 and the collar 18 of the rotational component 12 may occur via movement of the manufacturing apparatus 50 toward the rotational component 12 and/or movement of the rotational component 12 toward the manufacturing apparatus 50. Further, relative rotation between the roller 52 and the rotational component 12 about the second axis 60 may be performed via rotation of the roller 52 about the second axis 60 relative to the rotational component 12 and/or rotation of the rotational component 12 relative to the roller 52 about the second axis 60.

In an exemplary implementation illustrated in FIG. 2, the manufacturing apparatus 50 includes a support base 66 that acts as a brace for the rotary system 10 (here, a portion of an electric motor assembly). Further, the manufacturing apparatus 50 includes the roller 52 that is configured to be moved via the manufacturing apparatus 50 toward the rotational component 12, rotate relative to the rotational component 12 about the second axis 60, and roll along the collar 18 of the rotational component 12 about the first axis 58 to form the flange 20. In the embodiment illustrated in FIGS. 3 and 4, the first and second rollers 62, 64 of the manufacturing apparatus 50 are configured to roll about the first axis 58 while in contact with the collar 18 of the rotational component 12 to form the flange 20 as the rotational component 12 is moved toward the first and second rollers 62, 64 and rotates about the second axis 60. In some implementations, the axis 14 about which the rotational component 12 is configured to rotate in operation of the rotary system 10 and the second axis 60 about which relative rotation between the rotational component 12 and the one or more rollers 62, 64 of the manufacturing apparatus 50 occurs are substantially parallel axes. In some implementations, the axis 14 and the second axis 60 are substantially collinear to each other.

Referring now to FIG. 7, a method 100 of assembling a resolver 22 with a rotational component 12 that is configured to rotate about an axis 14 includes a step 102 of disposing the resolver 22 about the collar 18 of the rotational component 12. In some implementations, at step 102, the resolver 22 is disposed about the collar 18 of the rotational component 12, such that the resolver 22 contacts the base portion 16 of the rotational component 12 that extends radially outboard relative to the collar 18. In some implementations, at step 102, the resolver 22 is disposed about the collar 18 of the rotational component 12, such that a locator tab 44 of the resolver 22 is received within the corresponding recess 38 defined by the collar 18 of the rotational component 12, as illustrated exemplarily in FIG. 3. In various implementations, at step 102, the collar 18 is not yet deformed to include the flange 20, as described further herein.

Referring still to FIG. 7, the method 100 can include a step 104 of deforming the collar 18 via forcible contact between the collar 18 and the roller 52 to form the flange 20. In various implementations, the flange 20 is formed from a portion of the collar 18 at step 104. The flange 20 extends radially outboard from an adjacent portion of the collar 18, and the resolver 22 is disposed axially between the base portion 16 of the rotational component 12 and the flange 20 to limit axial deformation of the resolver 22. In some implementations, at the step 104 of deforming the collar 18, the roller 52 rolls about the first axis 58 as relative rotation of the roller 52 in the rotational component 12 occurs about the second axis 60, such that the roller 52 rolls about at least a portion of the collar 18 in forming the flange 20. In some implementations at the step 104 of deforming the collar 18, the rotational component 12 moves axially toward the roller 52 via a force applied to the rotational component 12. In some implementations, at the step 104 of deforming the collar 18, the roller 52 moves axially toward the rotational component 12 via a force applied to the roller 52. In some implementations, wherein the roller 52 is the first roller 62 and the second roller 64 is in a spaced relationship with the first roller 62, in the step 104 of deforming the collar 18, the first and second rollers 62, 64 roll about the first axis 58 as relative rotation of the first and second rollers 62, 64 and the rotational component 12 occurs about the second axis 60, such that the first and second rollers 62, 64 roll about the collar 18 in forming the flange 20. In some embodiments, in the step 104 of deforming the collar 18, the roller 52 rotates relative to the rotational component 12 about the second axis 60. In some implementations, in the step 104 of deforming the collar 18, the rotational component 12 rotates relative to the roller 52 about the second axis 60.

The rotational component 12 and the method 100 of the present disclosure may provide a variety of advantages. First, sandwiching the resolver 22 between the flange 20 of the rotational component 12 and the base portion 16 of the rotational component 12 may advantageously limit axial deformation (i.e. delamination) of the resolver 22 in subsequent operation of the rotary system 10 in which the rotational component 12 and resolver 22 are utilized. Second, forming the flange 20 from the collar 18 utilizing the one or more rollers 62, 64 in manufacturing may advantageously result in more evenly distributed stress on the rotational component 12, as well as a lower maximum force applied to the collar 18 of the rotational component 12 at any given point in the process of securing the resolver 22 to the rotational component 12. Third, utilizing the first and second rollers 62, 64 that are operable to roll about the first axis 58 in the manufacturing process to secure the resolver 22 to the rotational component 12 may further distribute force applied to the rotational component 12.

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

10 rotary system
12 rotational component
14 axis
16 base portion
18 collar
20 flange
22 resolver
24 electric motor assembly
26 rotor
28 rotor hub
30 central component
32 outer component
34 torque converter
36 impeller
38 recess
40 first recess
42 second recess
44 locator tab
46 first locator tab
48 second locator tab
50 manufacturing apparatus
52 roller
54 tapered surface
56 corner
58 first axis
60 second axis
62 first roller
64 second roller
66 support base
100 method
102 step
104 step

What is claimed is:

1. A rotary system, comprising:
a rotational component operable to rotate about an axis and having a base portion, a collar that extends axially outward from the base portion, and a flange that extends radially-outboard from the collar; and
a resolver disposed axially between the base portion and the flange, wherein the base portion and the flange contact the resolver to limit axial deformation of the resolver.

2. The rotary system of claim 1, wherein the collar defines a recess, and the resolver includes a locator tab that is received within the recess defined by the collar.

3. The rotary system of claim 2, wherein the collar continuously extends circumferentially from a first portion of the recess to a second portion of the recess.

4. The rotary system of claim 1, wherein the collar defines a plurality of recesses and the resolver includes a corresponding plurality of locator tabs respectively received within the plurality of recesses.

5. The rotary system of claim 4, wherein the plurality of recesses includes a first recess and a second recess in a spaced relationship with and adjacent to the first recess, wherein a portion of the collar continuously extends circumferentially from the first recess to the second recess at least 60 degrees.

6. The rotary system of claim 1, wherein the rotational component is a portion of a torque converter.

7. The rotary system of claim 6, wherein the rotational component is an impeller of the torque converter.

8. The rotary system of claim 1, wherein the rotational component is a portion of an electric motor assembly.

9. The rotary system of claim 8, wherein the rotational component is a portion of a rotor hub of the electric motor assembly.

10. A method of assembling a resolver with a rotational component configured to rotate about an axis, comprising the steps of:
disposing a resolver about a collar of the rotational component, such that the resolver contacts a base portion of the rotational component that extends radially outboard relative to the collar; and
deforming the collar via forcible contact between the collar and a roller to form, from a portion of the collar, a flange that extends radially-outboard from an adjacent portion of the collar, wherein the resolver is disposed axially between the base portion and the flange to limit axial deformation of the resolver.

11. The method of claim 10, wherein, in the step of deforming the collar, the roller rolls about a first axis as relative rotation of the roller and the rotational component occurs about a second axis, such that the roller rolls about at least a portion of the collar in forming the flange.

12. The method of claim 11, wherein, in the step of deforming the collar, the rotational component moves axially toward the roller via a force applied to the rotational component.

13. The method of claim 12, wherein, in the step of deforming the collar, the roller moves axially toward the rotational component via a force applied to the roller.

14. The method of claim 11, wherein the roller is a first roller, and a second roller, in a spaced relationship with the first roller, is operable to roll about the first axis, wherein, in the step of deforming the collar, the first and second rollers roll about the first axis as relative rotation of the first and second rollers and the rotational component occurs about the second axis, such that the first and second rollers roll about the collar in forming the flange.

15. The method of claim 11, wherein the second axis is substantially colinear to the axis about which the rotational component is configured to rotate.

16. The method of claim 11, wherein, in the step of deforming the collar, the roller rotates relative to the rotational component about the second axis.

17. The method of claim 11, wherein, in the step of deforming the collar, the rotational component rotates relative to the roller about the second axis.

18. The method of claim 10, wherein the rotational component is an impeller for a torque converter.

19. The method of claim 10, wherein the rotational component is a portion of a rotor hub for an electric motor.

20. An electric motor assembly, comprising:
a rotor configured to rotate about an axis;
a rotor hub coupled with the rotor and having a central component, a portion of which is axially aligned with the rotor, and an outer component mounted to the central component at a position that is axially offset from the rotor, wherein the outer component comprises:
a base portion;
a collar that extends axially outward from the base portion; and
a flange that extends radially-outboard from the collar distally from the base portion; and
a resolver disposed axially between the base portion and the flange, wherein the base portion and the flange contact the resolver to limit axial deformation of the resolver.
